(19) United States
(12) Patent Application Publication
(10) Pub. No.: US 2025/0191109 A1
(43) Pub. Date: Jun. 12, 2025

(54) CPU FOR IMPLEMENTING A GRAPHICS PROCESSING PIPELINE

(71) Applicant: Imagination Technologies Limited, Kings Langley (GB)

(72) Inventor: Kenneth Christian Rovers, Hertfordshire (GB)

(21) Appl. No.: 18/938,826

(22) Filed: Nov. 6, 2024

(30) Foreign Application Priority Data
Nov. 6, 2023 (GB) 2316993.1

(51) Int. Cl. G06T 1/20

(52) U.S. Cl. CPC G06T 1/20

(57) ABSTRACT

A central processing unit for implementing a graphics processing pipeline which comprises a plurality of graphics processing tasks, the central processing unit comprising: one or more distinct graphics processing modules configured in dedicated hardware, wherein each of the one or more distinct graphics processing modules is configured to perform one of the graphics processing tasks of the graphics processing pipeline; and an execution unit configured to execute instructions of an instruction set for implementing the graphics processing pipeline, wherein the execution unit is configured to call each of the one or more distinct graphics processing modules using a respective instruction of the instruction set to perform its respective graphics processing task of the graphics processing pipeline.

### CROSS-REFERENCE TO RELATED APPLICATIONS AND CLAIM OF PRIORITY

This application claims foreign priority under 35 U.S.C. 119 from United Kingdom patent application No. 2316993.1 filed on 6 Nov. 2023, the contents of which are incorporated by reference herein in their entirety.

### TECHNICAL FIELD

The present disclosure relates to a central processing unit (CPU) for implementing a graphics processing pipeline. In particular, acceleration of one or more graphics processing tasks of a graphics processing pipeline is achieved using one or more graphics processing modules implemented on a CPU.

### BACKGROUND

Graphics processing, e.g. for rendering images representing frames of a video game, typically involves a lot of computation. As such, often, alongside a CPU in a computing system, a dedicated graphics processing unit (GPU) is implemented for the purpose of performing the graphics processing. Such a dedicated graphics processing unit (GPU) may be customised specifically for the purpose of efficiently performing graphics processing. For example, graphics processing often involves performing the same computations for many different (but similar) pixels, so GPUs may be configured with processing logic that can process multiple data items in parallel. The use of a dedicated GPU alongside a CPU tends to provide a computing system which can perform graphics processing efficiently. However, a GPU takes up a considerably amount of silicon area on a chip, so implementing a separate GPU alongside a CPU will increase the physical size (and therefore cost) of the chip and increase the complexity of the system design.

In some devices there are tight constraints on the complexity/size and/or cost of the chip, so it is not always suitable to implement a separate GPU alongside a CPU. Furthermore, in some devices, graphics processing is not the main focus, so again it may be considered unsuitable to implement a separate GPU alongside a CPU. As such, in some systems, a CPU is implemented, without a separate GPU, and it is the CPU that performs any graphics processing that is to be performed. Implementing graphics processing on a CPU may be referred to as “software rendering”, which typically cannot achieve the same level of performance in performing graphics processing, but does avoid the need to implement a separate GPU in the system.

It is an objective of this disclosure to improve the performance of a CPU when performing graphics processing, without using a separate, dedicated GPU.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to a first aspect of this disclosure there is provided a central processing unit for implementing a graphics processing pipeline which comprises a plurality of graphics processing tasks, the central processing unit comprising: one or more distinct graphics processing modules configured in dedicated hardware, wherein each of the one or more distinct graphics processing modules is configured to perform one of the graphics processing tasks of the graphics processing pipeline; and an execution unit configured to execute instructions of an instruction set for implementing the graphics processing pipeline, wherein the execution unit is configured to call each of the one or more distinct graphics processing modules using a respective instruction of the instruction set to perform its respective graphics processing task of the graphics processing pipeline.

The central processing unit described above may be configured to perform one or more of the plurality of graphics processing tasks of the graphics processing pipeline without using a distinct graphics processing module configured in dedicated hardware.

The central processing unit described above, wherein each of the one or more graphics processing tasks of the graphics processing pipeline that the respective one or more distinct graphics processing modules are configured to perform may be at a level between a level of elemental mathematical functions and a level of a full draw call to a graphics processing unit.

The central processing unit described above, wherein the one or more graphics processing tasks of the graphics processing pipeline that the respective one or more distinct graphics processing modules are configured in dedicated hardware to perform may be selected from the plurality of graphics processing tasks of the graphics processing pipeline based on an assessment of an improvement to the implementation of the graphics processing pipeline that would be achieved by performing the graphics processing task in a distinct graphics processing module configured in dedicated hardware compared to performing the graphics processing task without using a distinct graphics processing module configured in dedicated hardware.

The central processing unit described above, may further comprise: a local memory; wherein the execution unit may be further configured to use the local memory when an associated one of the one or more distinct graphics processing modules is called.

The central processing unit described above, wherein the local memory may comprise a separate memory for each of the one or more distinct graphics processing modules.

The central processing unit described above, wherein the local memory may comprise a non-cached local memory that includes a separate memory port.

The central processing unit described above, wherein the instruction set architecture may comprise instructions specific to each of the graphics processing modules that can be called by the execution unit.

The central processing unit described above, wherein the one or more graphics processing tasks may comprise one or more of: texture processing, rasterization, encoding, decoding, blending, blitting. Graphics state management, tessellation, clip, cull, perspective divide, viewport transform, scan conversion, hidden surface removal, multi-sampling, tiling, ray casting, ray tracing, compression, decompression, interpolation, gathering, format converting, memory management, texture mapping, texture decoding, texture filtering, testing, and post-processing.

The central processing unit described above, wherein the one or more distinct graphics processing modules may be configured in fixed function circuitry.

The central processing unit described above, wherein the instruction set may be a RISC-V instruction set.

The central processing unit described above, wherein the execution unit may be further configured to receive an output from the one or more distinct graphics processing modules configured in dedicated hardware, wherein the output represents a result of the graphics processing task performed by the one or more distinct graphics processing modules.

According to a further aspect of this disclosure there is provided a computer-implemented method for implementing a graphics processing pipeline which comprises a plurality of graphics processing tasks, on a central processing unit, the method comprising: executing instructions of an instruction set on an execution unit of the central processing unit for implementing the graphics processing pipeline; and performing one or more of the graphics processing tasks of the graphics processing pipeline using a respective one or more distinct graphics processing modules of the central processing unit, wherein each of the one or more distinct graphics processing modules is configured in dedicated hardware to perform one of the graphics processing tasks of the graphics processing pipeline, wherein said executing instructions of the instruction set comprises calling each of the one or more distinct graphics processing modules using a respective instruction of the RISC-V instruction set to perform its respective graphics processing task of the graphics processing pipeline.

The method described above, wherein the central processing unit may perform one or more of the plurality of graphics processing tasks of the graphics processing pipeline without using a distinct graphics processing module configured in dedicated hardware.

The method described above, wherein each of the one or more graphics processing tasks of the graphics processing pipeline that are performed by the one or more distinct graphics processing modules may be at a level between a level of elemental mathematical functions and a level of a full draw call to a graphics processing unit.

The method described above, wherein the central processing unit may further comprise a local memory, and wherein the method may further comprise: using the local memory when an associated one of the one or more distinct graphics processing modules is called.

The method described above, wherein the local memory may comprise a separate memory for each of the one or more distinct graphics processing modules.

The method described above, wherein the local memory may comprise a non-cached local memory that includes a separate memory port.

The method described above, wherein the instruction set architecture may comprise instructions specific to each of the graphics processing modules called by the execution unit.

The method described above, wherein the instruction set may be a RISC-V instruction set.

The method described above, wherein the method may further comprise: receiving, at the execution unit, an output from the one or more distinct graphics processing modules configured in dedicated hardware, wherein the output represents a result of the graphics processing task performed by the one or more distinct graphics processing modules.

The method described above, wherein the one or more graphics processing tasks may comprise one or more of: texture processing, rasterization, encoding, decoding, blending, blitting, graphics state management, tessellation, clip, cull, perspective divide, viewport transform, scan conversion, hidden surface removal, multi-sampling, tiling, ray casting, ray tracing, compression, decompression, interpolation, gathering, format converting, memory management, texture mapping, texture decoding, texture filtering, testing, and post-processing.

According to a further aspect of this disclosure there is provided a central processing unit that may be configured to perform the method described above.

According to a further aspect of this disclosure there is provided a method of manufacturing, using an integrated circuit manufacturing system, a central processing unit as described above.

According to a further aspect of this disclosure there is provided an integrated circuit definition dataset that, when processed in an integrated circuit manufacturing system, may configure the integrated circuit manufacturing system to manufacture a central processing unit as described above.

The CPU may be embodied in hardware on an integrated circuit. There may be provided a method of manufacturing, at an integrated circuit manufacturing system, a CPU. There may be provided an integrated circuit definition dataset that, when processed in an integrated circuit manufacturing system, the system to manufacture a CPU. There may be provided a non-transitory computer readable storage medium having stored thereon a computer readable description of a CPU that, when processed in an integrated circuit manufacturing system, causes the integrated circuit manufacturing system to manufacture an integrated circuit embodying a CPU.

There may be provided an integrated circuit manufacturing system comprising: a non-transitory computer readable storage medium having stored thereon a computer readable description of the CPU; a layout processing system configured to process the computer readable description so as to generate a circuit layout description of an integrated circuit embodying the CPU; and an integrated circuit generation system configured to manufacture the CPU according to the circuit layout description.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows an example graphics processing pipeline that may be implemented on a central processing unit;

FIG. 2 shows an example of a first CPU configuration in which local memory is shared;

FIG. 3 shows an example of a second CPU configuration in which dedicated memory is provided for each graphics processing module embodied in dedicated hardware;

FIG. 4 shows an example method for implementing a graphics processing pipeline on a central processing unit;

FIG. 5 shows a computer system in which a graphics processing system is implemented; and

FIG. 6 shows an integrated circuit manufacturing system for generating an integrated circuit embodying a graphics processing system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

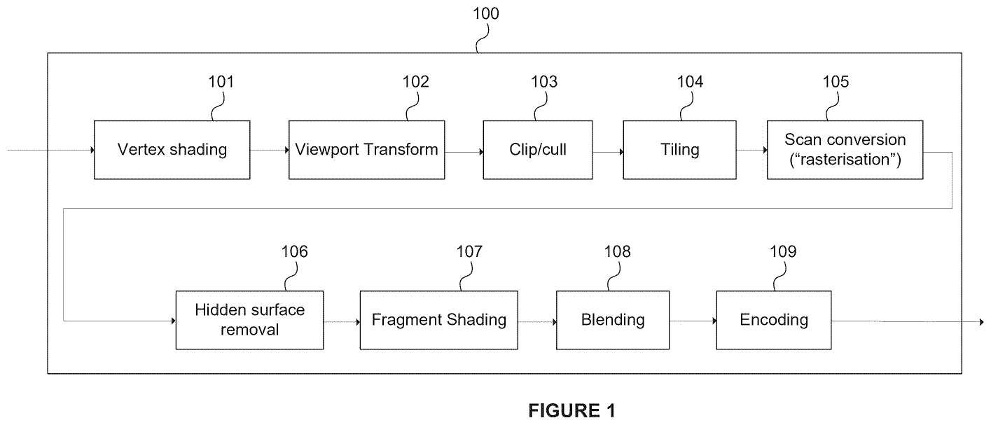

FIG. 1 shows an example graphics processing pipeline 100 that may be implemented on a central processing unit (CPU). The central processing unit may be a processing unit that is configured for processing a variety of processing tasks and that is not specialised primarily for the processing of graphics. In other words, the central processing unit of this disclosure may be one in which the primary task of the processing unit is not graphics processing, unlike a dedicated graphics processing unit (GPU), the primary function of which is graphics processing. A central processing unit may be understood to be a general-purpose processor, having an instruction set architecture (ISA) that provides the target for compilers and OSs, that is advantageous for running a wide variety of tasks, rather than a more focussed processor that will be advantageous for a performing a particular task e.g., graphics or neural network processing but not perform optimally when performing other tasks e.g., those that have lots of control flow changes. The general-purpose processing achieved by a central processing unit is also different from dedicated compute processing, since compute processing relates to data-dominated workloads (such as graphics) rather than workloads that include multiple control flow changes. Furthermore, a CPU has a programming model that may use sequential state updates. This is in contrast to other processing units e.g., a GPU, which may implement single instruction multiple threads (SIMT) rather than sequential state updates. Therefore, the central processing unit described herein may be considered to be capable of solving multiple problems itself, in addition to some targeted graphics acceleration, while contrastingly processing units such as a GPU that generally include of a vendor provided driver and firmware that has a graphics API interface and are therefore not programmed or capable of being programmed to be used for general purpose processing to solve multiple problems without receiving input from a further processing unit such as, for example, a CPU. A CPU may be considered to be the ‘main’ processing unit in a processing system, that receives work from inputs to the processing system, whereas a GPU receives work from another processor in the processing system (e.g. a CPU). The central processing unit of this disclosure may extend the ISA, in combination with a software renderer providing a graphics API, rather than providing a graphics API directly.

The graphics processing pipeline 100 is a functional pipeline comprising a series of graphics processing tasks. The graphics processing tasks shown in the example of FIG. 1 are vertex shading 101, viewport transform 102, clip/cull 103, tiling 104, scan conversion (which may be referred to as rasterisation) 105, hidden surface removal 106, fragment shading 107, blending 108 and encoding 109. This is just one example, and in other examples the graphics processing pipeline may include more or fewer and/or different graphics processing tasks. A person skilled in the art would understand what each of the graphics processing tasks (101 to 110) shown in FIG. 1 would do. As a brief explanation, the vertex shading task 101 may involve executing a vertex shader program to process vertices which define primitives in a scene being rendered; the viewport transform task 102 transforms the primitives into a rendering space for rendering an image of the scene; the clip/cull task 103 can cull primitives that do not lie within a view frustum within the scene corresponding to a viewpoint from which the scene is being rendered; the rendering space may be subdivided into a plurality of “tiles” (or regions) and the tiling task 104 includes determining which of the primitives are present within each of the tiles; the scan conversion task 105 involves determining fragments for primitives, where a primitive fragment is determined for each sample position (e.g. for each pixel position) that the primitive overlaps; the hidden surface removal task 106 involves performing depth tests to determine whether any fragments are hidden by other (e.g. closer) fragments within the scene, and removing/discarding the hidden fragments; the fragment shading 107, which may form a part of fragment processing and include texture processing, may involve fetching texels of a texture, performing texture filtering on the texels to determine a texture value to be applied to a primitive fragment, it may also include iteratively computing colours, texture coordinates per pixel; the blending task 108 involves blending fragments together to form rendered pixel values; and the encoding task 109 involves encoding (e.g. compressing) the rendered pixel values, wherein the outputs from the encoding task 109 (i.e. the output from the graphics processing pipeline 100) may be stored in a frame buffer. Each of the tasks (101 to 109) shown in FIG. 1 typically includes many operations/computations. The example shown in FIG. 1 is an implementation of a tile-based deferred rendering system in which tasks 101 to 104 form a geometry processing phase, tasks 105 to 108 form a fragment processing phase, and tasks 108 and 109 are part of a post-processing phase, which in some systems may be considered to be part of the fragment processing phase and in other systems may be considered to be part of a different, further, phase. Other examples might not be tile-based and/or might not implement deferred rendering.

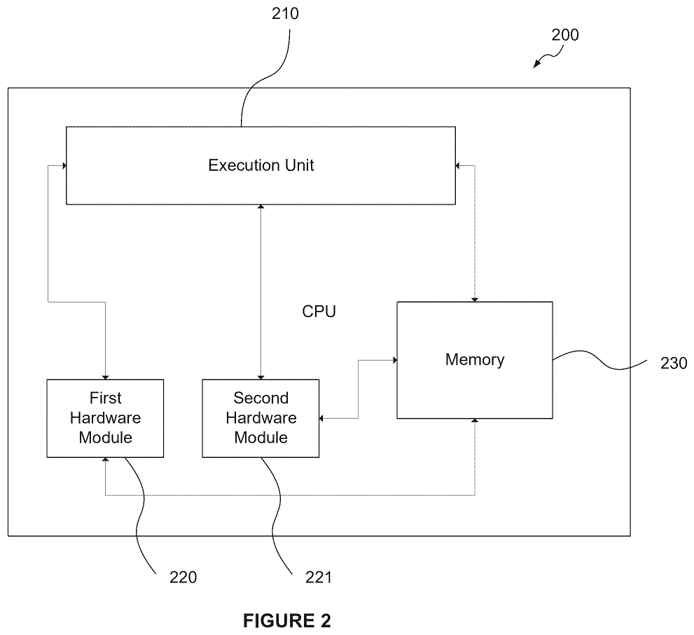

The present disclosure provides a central processing unit (CPU) for accelerating graphics processing tasks of the graphics processing pipeline 100 using one or more graphics processing modules implemented in dedicated hardware on the CPU. Rather than accelerating the entire graphics processing pipeline (e.g. as a GPU would), the CPU described herein is capable of accelerating only specific aspects/graphics processing tasks that form part of a graphics processing pipeline 100 implemented on a CPU. Some parts/tasks of the graphics processing pipeline 100 are not accelerated in hardware. Graphics processing tasks of the graphics processing pipeline 100 may be configured to be accelerated with dedicated hardware modules (e.g. implemented in fixed function circuitry), which can be called using CPU extensions, in order to accelerate 2D and 3D graphics. Such dedicated hardware may be used for compute-intense or communication-intense bottlenecks in the processing pipeline. The CPU of the present disclosure may comprise one or more distinct graphics processing modules configured in dedicated hardware, where each of the one or more distinct graphics processing modules is configured to perform one of the graphics processing tasks of the graphics processing pipeline 100. For example, FIG. 2 shows an example of a CPU 200. The CPU 200 comprises an execution unit 210 configured to execute software instructions, a first graphics processing module 220, a second graphics processing module 221 and a memory 230.

The graphics processing pipeline 100 is a functional pipeline of processes/tasks that are performed to implement graphics processing, e.g. for rendering images of computer generated scenes. The programmable processes/tasks of a graphics processing pipeline 100 may include a vertex shader, hull shader, domain shader, geometry shader, mesh shader, and fragment shader. Each graphics processing task can be performed by software, e.g. by the software renderer running on regular CPU hardware, or at least partially performed by dedicated hardware. A software renderer may also be used in compiling to vector/matrix operations for shaders and compiling custom instructions for accelerated (fixed function) parts of the processing pipeline 100. The dedicated hardware may be considered an extension of the CPU utilised by specific instructions of the CPU instruction set. Examples of graphics processing tasks that may be suitable for being accelerated using dedicated hardware modules are fragment shading 107 (which may include texture processing), rasterization 105, encoding 109, decoding, blending 108, and blitting, graphics state management, assemblers (input/vertex, tessellation, geometry primitive, fragment), tessellation, clip, cull, perspective divide, viewport transform, scan conversion/rasterisation, hidden surface removal, multi-sampling, tilling (engine), ray casting, ray tracing, compress/decompress/interpolate/gather/format conversion (of various data), memory management, texture mapping (level-of-detail computation, texel address generation), texture decoding (acts decoding, etc, decoding, bc decoding, texture retrieval, texture caching), texture filtering (bilinear, trilinear, anisotropic), testing (ownership, scissor, stencil, depth, alpha), blending (interpolating), post-processing (colour space conversion/gamma conversion, format conversion, compression, masking). Although it should be understood that this list is non exhaustive and any other graphics processing tasks of the graphics processing pipeline, e.g., tasks that are not implemented by shader programs, may also be accelerated using dedicated hardware modules implemented in the CPU of this disclosure. A further example of a task at a render pipeline level that may be accelerated in a dedicated hardware module is bilinear interpolation. Graphics processing tasks may also be thought of as subsections of larger graphics processing tasks, for example, an example of a graphics processing task may be texture mapping, which forms part of the graphics processing task of texture processing. Both texture mapping and texture processing as a whole may therefore be considered texture processing tasks according to this disclosure. Some of these graphics processing tasks can be seen in FIG. 1, but the graphics processing pipeline of FIG. 1 may also include further graphics processing tasks, e.g., individual parts of fragment shading such as texture processing that may include texture decoding, level-of-detail computation or texture filtering can be considered to be graphics processing tasks which may be accelerated using dedicated hardware modules in the CPU.

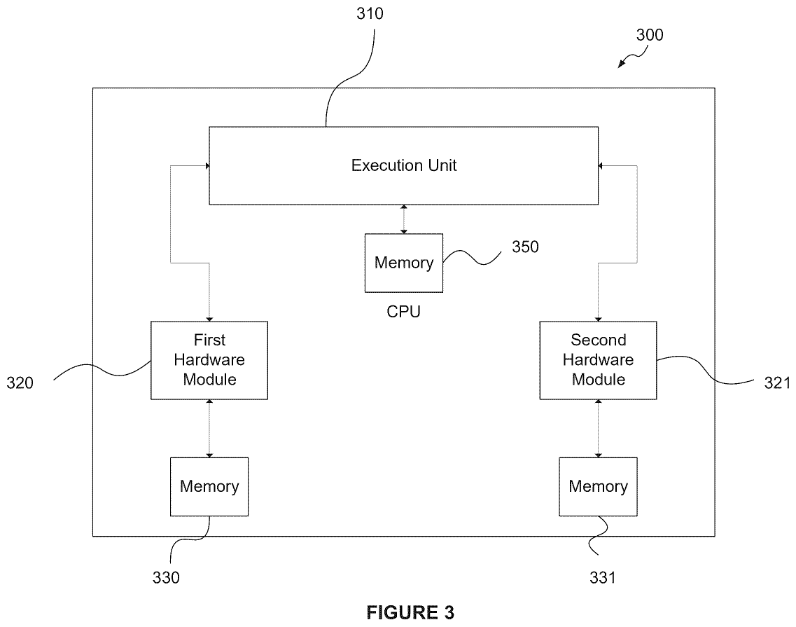

The graphics processing pipeline 100 may be implemented on the CPU 200 as one or more module, each module configured to perform a specific task for example, one module may perform texture processing and another module may perform encoding. The modules implemented on the CPU 200 may be thought of as connected directly or indirectly, for example the modules may each be connected to the execution unit of the CPU 200 such that the work performed by each module is output back to the execution unit, which may then call a further (second) module to perform its function or alternatively proceed to the next task embodied in hardware, such a configuration may be seen in relation to FIGS. 2 and 3. Alternatively, the modules implemented on the CPU 200 may be arranged either in hardware or software in a series, in which case, if it is optimal to do so, the modules may be configured such that processing of the pipeline includes passing information, and the result of the tasks performed by each module, directly between modules.

The modules of the pipeline implemented by the CPU 200 may themselves be distinct hardware modules or may be distinct software modules that are intended to perform that specific task of the graphics processing pipeline 100. In some cases, one or more of the distinct graphics processing modules may be configured in fixed function circuitry capable of performing fixed logic functions. In other cases, there may be provided circuitry that is partially fixed in function and partially programmable, for example a blending unit may support a number of different blending modes, but each mode may perform a fixed function. Such a configuration can lead to significant acceleration of the blending process approaching that of purely fixed function circuitry. However, where distinct and dedicated hardware modules are implemented for a graphics processing task, the task can be performed comparatively faster than if the same task were performed by a software implementation.

Each of the graphics processing tasks described herein that are configured to be performed by the respective one or more distinct graphics processing modules are at a level between a level of elemental mathematical functions and a level of a full draw call to a graphics processing unit. In other words, the graphics processing tasks performed by the modules of the CPU may not be of the order of the most elementary mathematical functions such as add, multiply/divide, etc. although the tasks may include these elementary mathematical functions as part of a more complex function. Such a complex function may be considered a composite function comprising a plurality of elementary mathematical functions, in one non-limiting example, elementary mathematical functions may include functions such as re-ordering and/or grouping functions. Similarly, the graphics processing tasks performed by the modules of the CPU may not be of the order/level of a full draw call to a graphics processing unit (GPU) separate from the CPU of this disclosure. A full draw call to a graphics processing unit may be considered to be at a level (a render pipeline level) at which all functions of the graphics processing pipeline 100 are considered as a whole as a single task and would be indistinguishable from calling a GPU separate from the CPU to perform the functions of the graphics processing pipeline 100 as a whole. The level of the graphics processing tasks that are configured to be performed by the graphics processing modules of the present disclosure are therefore between these two levels and may be thought of as at an intermediate level comprising a complex collection (composite) of elementary mathematical functions that represents a portion of a graphics processing pipeline 100.

Such a graphics processing pipeline 100 that may be implemented on the CPU 200 of this disclosure can be seen in FIG. 1, which demonstrates some of the graphics processing tasks that may be performed as part of the graphics processing pipeline 100. As can be seen in FIG. 1 each of the graphics processing tasks may be performed sequentially as part of the pipeline. FIG. 1 illustrates just an example pipeline and with example graphics processing tasks, while it should be understood that other graphics processing tasks may be present. Furthermore, FIG. 1 also illustrates an example of only a portion of a pipeline implemented on the CPU, additional functions may also form part of the pipeline and may, in some cases, be interspersed with the graphics processing tasks shown in FIG. 1.

In examples described herein, the execution unit 210 of the CPU 200 is configured to execute instructions of an instruction set for implementing the graphics processing pipeline 100. In some cases, the instruction set of this disclosure is a RISC-V instruction set. The execution unit 210 may be configured to call each of the one or more distinct graphics processing modules using a respective instruction of the instruction set to perform its respective graphics processing task of the graphics processing pipeline. In other words, the instruction set may be customised so that one or more of the tasks of the graphics processing pipeline can be performed using a bespoke instruction of the instruction set that is executed on the execution unit 210. The instruction set architecture allows for customisation of the capabilities of the pipeline that is to be executed by the CPU. In other words, the instruction set architecture can be adapted to optimise only some of the graphics processing tasks (by implementing them in dedicated hardware modules within the CPU) and not others within the pipeline (which may be implemented in software by executing instructions on the execution unit 210). In some cases, this can mean that the CPU is configured to perform one or more of the plurality of graphics processing tasks of the graphics processing pipeline without using a distinct graphics processing module configured in dedicated hardware. This should be understood to mean that only some of the graphics processing modules may be implemented as dedicated hardware modules in come cases. When only some of the graphics processing modules are implemented in dedicated hardware, one or more of the remaining graphics processing modules may be implemented in software, i.e. not accelerated in dedicated hardware. It is noted that the CPU may utilise the RISC-V compatible implementations of graphics APIs such as OpenGL, OpenCL, or Vulkan.

The instruction set architecture may comprise instructions that are specific to each of the graphics processing modules that can be called by the execution unit 210. In other words, the RISC-V instruction set may include distinct individual instructions and/or groups of instructions that represent each graphics processing task implemented by the modules of the graphics processing pipeline.

The instruction set is one such customisable instruction set that allows for multithreading to be used in the execution of instructions without the need to employ a multicore system within the CPU. The advantage this provides is that the CPU may implement the instruction set to accelerate some graphics processing tasks in dedicated hardware while simultaneously performing other work. In some cases, the instruction set of this disclosure is a RISC-V instruction set.

As shown in the example of FIG. 2, when executing instructions of the instruction set to implement the graphics processing pipeline the execution unit 210 may execute an instruction that calls one of the distinct graphics processing modules (220 or 221) to perform its graphics processing task using dedicated hardware. The CPU 200 may comprise this dedicated hardware as shown in FIG. 2. FIG. 2 illustrates an example in which there are two such dedicated hardware modules, a first dedicated hardware module 220 and a second dedicated hardware module 221. Each module of the first dedicated hardware module 220 and the second dedicated hardware module 221 may be used to optimise different tasks of the graphics processing pipeline executed by the execution module. In the case of FIG. 2, the first dedicated hardware module 220 may be called by the execution unit 210, e.g. such that the graphics processing module performing the task of texture processing is performed by the first dedicated hardware module 220 and the second dedicated hardware module 221 may be called by the execution unit 210, e.g. such that the graphics processing module performing the task of encoding is performed by the second dedicated hardware module 221. In this way it is possible to provide separate and distinct dedicated hardware modules associated with each of one or more of the tasks of the graphics processing pipeline that are desired to be accelerated. The dedicated hardware modules may be thought of as performing the same function as dedicated hardware modules that may be present in a GPU but the dedicated hardware modules of this disclosure present on the CPU are configured to be controlled and called by the instructions, which may in some cases be RISC-V instructions, executed by the execution unit 210. The graphics processing tasks are at a “render pipeline level” as discussed above and therefore although a dedicated hardware module on the present CPU may perform the same graphics processing task as a hardware module on a separate GPU, the two modules would not instructionally correspond to one another and would be implemented differently. Furthermore, implementing the dedicated hardware modules as part of the CPU avoids implementing a separate GPU, so the silicon area of the system as a whole can be reduced.

When only a portion (i.e. some but not all of the tasks) of the graphics processing pipeline is to be accelerated, the central processing unit 200 of this disclosure may be configured such that the one or more graphics processing tasks of the graphics processing pipeline that the respective one or more distinct graphics processing modules are configured in dedicated hardware to perform are selected from the plurality of graphics processing tasks of the graphics processing pipeline. This selection is made at design time, i.e. when the CPU is being designed rather than when the CPU is processing data for real (i.e. rather than at runtime). Furthermore, this selection is made based on an assessment of an improvement to the implementation of the graphics processing pipeline that would be achieved by performing the graphics processing task in a distinct graphics processing module configured in dedicated hardware compared to performing the graphics processing task without using a distinct graphics processing module configured in dedicated hardware. In other words, the one or more graphics processing tasks that are selected to be implemented in dedicated hardware, from the plurality of graphics processing tasks, are chosen by making an assessment regarding which parts of the graphics processing pipeline are functioning sub-optimally or are slowing the execution of the graphics processing pipeline down, i.e. by identifying which tasks are ‘bottlenecks’ of the graphics processing pipeline. Such an assessment may be made by analysing each of the graphics processing tasks and determining that the complexity of the instructions that are performed for, and define, each graphics processing task. In other words, the configuration of the graphics processing tasks that are to be accelerated by being configured in dedicated hardware may be adapted based on the expected use of the CPU. For example, if the CPU is for a use-case in which it is expected to encounter graphics processing tasks with lots of primitives but which require only little or basic texturing and/or shading, the initial processing capabilities of the CPU may be geometry-limited, in which case it will be beneficial to accelerate tasks in the graphics processing pipeline that handle the processing of the geometry in order to accelerate the CPU graphics processing capabilities. Conversely, in an alternate example, if the CPU is for a use-case in which it is expected to encounter graphics processing tasks with fewer primitives but more complex texturing than the above example, the initial processing capabilities of the CPU may be fragment-limited, in which case it will be beneficial to accelerate tasks in the graphics processing pipeline that handle the processing of the fragment processing in order to accelerate the CPU graphics processing capabilities.

When an instruction or set of instructions comprised in a task are identified as being sub-optimally implemented as software, the graphics processing task to which the instructions belong may be configured to be performed in dedicated hardware. This assessment may be made prior to configuring the CPU 200 and integrating the dedicated hardware as part of the CPU 200. Furthermore, the assessment may also be made and the graphics processing modules to be accelerated selected based on a cost to performance improvement trade off that is associated with the implementation of graphics processing modules in dedicated hardware. In this way, lightweight graphics acceleration can be provided in some cases by re-using CPU infrastructure.

FIG. 2 also demonstrates a CPU 200 configuration in which the CPU 200 further comprises an integrated local memory 230. The execution unit 210 and/or the hardware modules 220 and 221 of this example may be configured to use the local memory 230 (i.e. read data from the memory and/or write data to the memory), e.g. when an associated one of the one or more distinct graphics processing modules is called. In other words, some of the one or more graphics processing modules may require access to a local memory 230 in order to perform their function and such graphics processing modules may therefore be thought of as associated with the local memory 230 integrally formed with the CPU 200. Such graphics processing modules may therefore access local memory 230 of the CPU 200 when an instruction from the RISC-V instruction set is reached that requires memory access. In such a scenario, the execution unit that is implementing the graphics processing pipeline will, at the appropriate time in the graphics processing pipeline, request access to the local memory 230 either on behalf of a software implemented module or a module that is embodied in dedicated hardware. The local memory 230 will then return the requested information to the execution module and/or to the appropriate graphics processing hardware module. When a graphics processing module is so configured by the RISC-V instruction set to require access to the local memory 230, said module can be thought of as being associated with the local memory 230. In some alternate configurations the local memory 230 may be a single central local memory 230 to the CPU 200 and may return information requested by the execution unit directly to the first and/or second hardware modules 220, 221 where the graphics processing module that has requested access to the local memory 230 is embodied in dedicated hardware shown as the either the first or second hardware module 220, 221 in FIG. 2. In a further example, the first and/or second hardware module 220, 221 may request access to the memory directly instead of the execution unit making the request on their behalf. In such cases, the dedicated hardware may be configured to request access to the local memory 230. In some cases, the local memory 230 may comprise a non-cached local memory 230 that may include a separate memory port (streaming memory port). The local memory may be separate from a standard L2 cache memory of the CPU in order to separate the performance of the graphics processing modules from other processes performed by the CPU. In this way the performance of the other processes performed by the CPU can be at least partially prevented from being detrimental to the graphics processing performance and vice-versa. The inputs to the local memory from the graphics processing modules may be write-only inputs and the outputs received by the graphics processing modules from the local memory may be read-only outputs.

The configuration of FIG. 2 illustrates an example in which the execution unit 210, the first hardware module 220 and the second hardware module 221 share a common local memory 230, however this may not always be the case. FIG. 3 shows an example of a CPU 300. The CPU 300 comprises an execution unit 310 configured to execute software instructions, a first graphics processing module 320, a second graphics processing module 321 and three separate memories 330, 331 and 350. FIG. 3 demonstrates an example configuration in which each of the dedicated hardware modules 320, 321 has an associated and separate memory 330, 331. Each memory 330, 331 may be specific to the dedicated hardware that implements the graphics processing module in question. In this way the use of the memory 330, 331 for each graphics processing module can also be optimised, e.g. so that the dedicated hardware modules 320, 321 can quickly and efficiently read data from, and write data to, its respective memory 330, 331. An advantage of providing separate memories 330, 331, within the CPU 300, for each of the graphics processing hardware modules 320, 321 is that the structure/configuration of the memory 330, 331 may be simplified and bespoke to the meet the requirements of the hardware module 320, 321 to which it is associated. Each memory 330, 331 associated with each of the dedicated hardware modules 320, 321 may only comprise information relevant to the function (i.e. the task) of that graphics processing module.

In some cases, the configuration of FIG. 3, which illustrates an example CPU 300 configuration similar to the configuration of the CPU 200 shown in FIG. 2, but in which there is a separate memory 330, 331 for each of the dedicated hardware modules 320, 321, may be combined in a configuration of a CPU 300 that also includes a local memory 350 that may be accessed by the software implemented graphics processing modules that are executed by the execution unit 310 (i.e. that are not optimised in dedicated hardware). In such case, a local memory 350 may also be provided (similar to the memory 230 of FIG. 2) and this local memory 350 may serve the portions or modules of the graphics processing pipeline that are not served by the dedicated and separate memory for each of the hardware modules 320, 321 as seen associated with the first hardware module 320 or the second hardware module 321 in FIG. 3. The memory described herein in FIGS. 2 and 3 thus allows the CPU to efficiently access memory which is particularly useful for handling the high memory bandwidth requirements that are usually associated with graphics processing.

As further shown in the example configuration of FIG. 3, the first and second dedicated hardware modules 320, 321 may not be connected to each other directly, and instead may be connected only through the execution unit 310. In such a configuration of the CPU 300 shown in FIG. 3, each of the first and second dedicated hardware modules 320, 321 are called by the execution unit 310 at the appropriate stage of the graphics processing pipeline. The first and/or second dedicated hardware module 320, 321, will then, upon being called, perform the graphics processing task which they embody and return the result to the execution unit 310. As such, the first dedicated hardware module 320 may be called by the execution unit 310, perform the graphics processing task with which it is associated, and return the result of the performed graphics processing task to the execution unit 310. In other words, the execution unit 310 may be further configured to receive an output from the one or more distinct graphics processing modules configured in dedicated hardware 320, 321, wherein the output represents a result of the graphics processing task performed by the one or more distinct graphics processing modules configured in dedicated hardware 320, 321. The execution unit 310 may then continue to execute the tasks in the graphics processing pipeline until the instruction set dictates that a further graphics processing task has been reached that may be embodied in dedicated hardware, and thus accelerated. The execution unit 310 may then, for example, call the second dedicated hardware unit 321 associated with the further graphics processing task. The second dedicated hardware unit 321 may then perform the graphics processing task and return the result to the execution unit 310 to continue processing of the graphics processing pipeline. In this example configuration, it is possible to ensure that each of the dedicated hardware modules associated with a graphics processing task are separate and distinct from the other dedicated hardware modules and can be optimised to perform one graphics processing task. This is advantageous compared to the configuration of GPUs and hardware pipelines, in that the execution unit 310 may have an overview and control of each of the graphics processing tasks allowing for more complete resource management of each task of the graphics processing pipeline while allowing each task that is desired to be accelerated to be individually customisable and isolated from the other graphics processing tasks that are to be accelerated.

The use of targeted hardware acceleration for graphics processing modules is useful as it allows the chosen specific graphics processing functions/tasks performed by each module of the graphics processing pipeline to be improved in a cost-effective manner compared to the addition of a dedicated GPU alongside the CPU. A further advantage is that because a GPU is not needed to achieve the graphics processing improvement, the space requirements are reduced and thus such a modified CPU setup of this disclosure would benefit more compact devices (e.g. smart devices), e.g. where graphics processing is not the primary focus, such that a separate GPU need not be implemented. An additional application of the present CPU is in the automotive industry for example, to display safety critical information e.g., the speedometer on the dashboard in which some graphics processing is required but not so much as to warrant the inclusion and cost of a dedicated GPU. Furthermore, such an implementation would provide the advantage of being silicon area saving in relation to the chips used for processing, while also reducing the complexity of the system by not requiring an additional ASIL certified GPU.

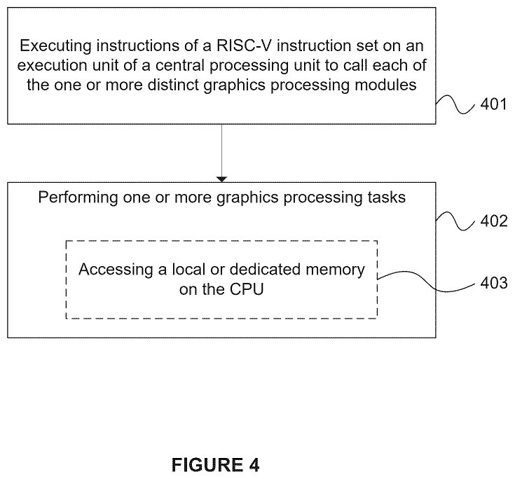

A flow chart for a method of implementing a graphics processing pipeline on a CPU is shown in FIG. 4 and will now be described. This method may be performed using the central processing unit (e.g. 200 or 300) described above and may include the features described above in relation to the central processing unit.

The method comprises executing instructions 401 of an instruction set on an execution unit of a central processing unit for implementing the graphics processing pipeline. The instruction set in this example may in some cases be a RISC-V instruction set. In this step the pipeline that is implemented on the CPU 200, 300 is executed in the form of RISC-V instructions. The pipeline implemented may not solely comprise graphics processing tasks as described above and may include other tasks not related to graphics processing. The instructions executed by the CPU 200, 300 are part of a RISC-V instruction set therefore allowing for the instruction set and thus the tasks performed by the CPU 200, 300 to be customisable. In the present case the instruction set implemented on the CPU 200, 300 may be customised to execute a graphics processing pipeline, e.g. as shown in FIG. 1.

Executing the instructions 401 may comprise calling each of the one or more distinct graphics processing modules using a respective instruction of the instruction set to perform its respective graphics processing task of the graphics processing pipeline. In other words, instructions comprised within the instruction set that execute on the CPU 200, 300 may include specific instructions that are configured to call each graphics processing module (including the hardware modules 220, 221, 320, 321) in order to execute a specific graphics processing task when an appropriate stage of the graphics processing pipeline is reached. Since the instruction set is inherently customisable, the user can customise the instruction set to execute different modules when different graphics processing tasks are required to be performed.

The CPU 200, 300 then performs one or more graphics processing tasks 402 in response to the execution of the instructions of the instruction set. In particular, the computer-implemented method may perform one or more of the graphics processing tasks of the graphics processing pipeline using a respective one or more distinct graphics processing hardware modules of the central processing unit. Performing the graphics processing tasks may be thought of as processing graphics data supplied to the CPU 200, 300 by executing instructions of the instruction set to process the graphics data according to the tasks. For example, if the graphics processing task is encoding, the graphics data would be encoded when the graphics processing task is performed. As described above the graphics processing tasks may vary and be customised in different examples, however some examples of graphics processing tasks that may be accelerated using dedicated hardware modules in the CPU include one or more of texture processing, rasterization, encoding, decoding, blending, and blitting. The graphics processing tasks may be performed 402 by one or more graphics processing modules some of which may be implemented in dedicated hardware within the CPU 200, 300. Each of the one or more distinct graphics processing modules may be configured in dedicated hardware to perform one of the graphics processing tasks of the graphics processing pipeline. Configuring each of the one or more distinct graphics processing modules in dedicated hardware provides the advantage that specific and selected modules from the one or more distinct graphics processing modules may be accelerated in order to enhance the performance of the graphics processing pipeline and the function of the CPU 200, 300 when performing graphics processing tasks.

In some instances, step 402 of performing one or more graphics processing tasks may include a distinct graphics processing module accessing 403 either: (i) a local memory on the central processing unit that may be associated with a plurality of the one or more distinct graphics processing modules, or (ii) a dedicated memory on the central processing unit that may be associated with the distinct graphics processing module. In such a case, one or more instructions from the RISC-V instruction set may be configured to call or request access from the local memory at the appropriate stage of the processing of the graphics processing pipeline such that the module which requires access to the local memory in order to perform the graphics processing task is permitted to access the local memory. In this example the local memory may be associated with multiple of the one or more graphics processing modules. The local memory may be so configured as described above in relation to FIGS. 2 and 3.

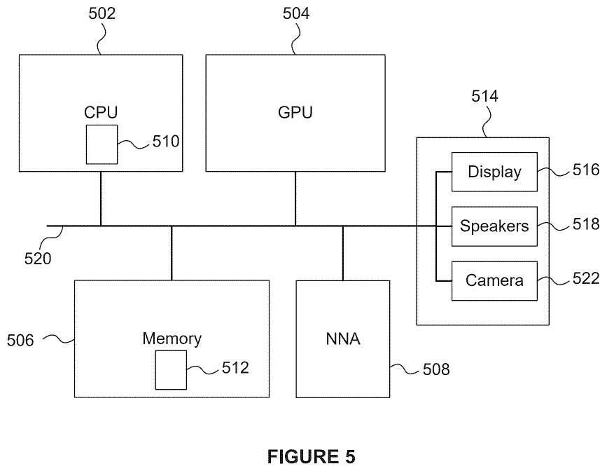

FIG. 5 shows a computer system in which processing systems described herein may be implemented. The computer system comprises a CPU 502, a GPU 504, a memory 506, a neural network accelerator (NNA) 508 and other devices 514, such as a display 516, speakers 518 and a camera 522. In other examples, one or more of the depicted components may be omitted from the system (e.g. the GPU, the NNA and/or one or more of the other devices 514 may be omitted). The components of the computer system can communicate with each other via a communications bus 520. The CPU 502 of FIG. 5 may be configured as described above in relation to FIGS. 1 to 4.

The graphics processing tasks of FIG. 1 are shown as comprising a number of functional blocks. This is schematic only and is not intended to define a strict division between different logic elements of such entities. Each functional block may be provided in any suitable manner. It is to be understood that intermediate values described herein as being formed by a graphics processing task need not be physically generated by the CPU at any point and may merely represent logical values which conveniently describe the processing performed by the graphics processing modules of the CPU between its input and output.

The graphics processing tasks and modules described herein may be embodied in hardware on an integrated circuit. The CPU described herein may be configured to perform any of the methods described herein. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a CPU configured to perform any of the methods described herein, or to manufacture a CPU comprising any apparatus described herein. An integrated circuit definition dataset may be, for example, an integrated circuit description.

Therefore, there may be provided a method of manufacturing, at an integrated circuit manufacturing system, a CPU as described herein. Furthermore, there may be provided an integrated circuit definition dataset that, when processed in an integrated circuit manufacturing system, causes the method of manufacturing a CPU to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS (RTM) and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

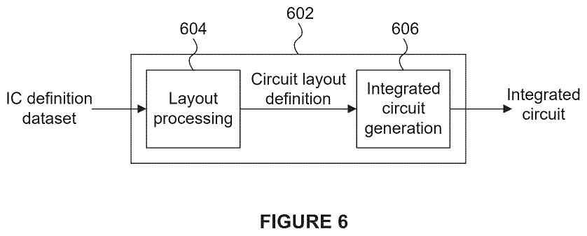

An example of processing an integrated circuit definition dataset at an integrated circuit manufacturing system so as to configure the system to manufacture a CPU will now be described with respect to FIG. 6.

FIG. 6 shows an example of an integrated circuit (IC) manufacturing system 602 which is configured to manufacture a CPU as described in any of the examples herein. In particular, the IC manufacturing system 602 comprises a layout processing system 604 and an integrated circuit generation system 606. The IC manufacturing system 602 is configured to receive an IC definition dataset (e.g. defining a CPU as described in any of the examples herein), process the IC definition dataset, and generate an IC according to the IC definition dataset (e.g. which embodies a CPU as described in any of the examples herein). The processing of the IC definition dataset configures the IC manufacturing system 602 to manufacture an integrated circuit embodying a CPU as described in any of the examples herein.

The layout processing system 604 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 604 has determined the circuit layout it may output a circuit layout definition to the IC generation system 606. A circuit layout definition may be, for example, a circuit layout description.

The IC generation system 606 generates an IC according to the circuit layout definition, as is known in the art. For example, the IC generation system 606 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 606 may be in the form of computer-readable code which the IC generation system 606 can use to form a suitable mask for use in generating an IC.

The different processes performed by the IC manufacturing system 602 may be implemented all in one location, e.g. by one party. Alternatively, the IC manufacturing system 1002 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a CPU without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 6 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 6, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

What is claimed is:

1. A central processing unit for implementing a graphics processing pipeline which comprises a plurality of graphics processing tasks, the central processing unit comprising:
one or more distinct graphics processing modules configured in dedicated hardware, wherein each of the one or more distinct graphics processing modules is configured to perform one of the graphics processing tasks of the graphics processing pipeline; and
an execution unit configured to execute instructions of an instruction set for implementing the graphics processing pipeline, wherein the execution unit is configured to call each of the one or more distinct graphics processing modules using a respective instruction of the instruction set to perform its respective graphics processing task of the graphics processing pipeline.

2. The central processing unit according to claim 1, wherein the central processing unit is configured to perform one or more of the plurality of graphics processing tasks of the graphics processing pipeline without using a distinct graphics processing module configured in dedicated hardware.

3. The central processing unit according to claim 1, wherein each of the one or more graphics processing tasks of the graphics processing pipeline that the respective one or more distinct graphics processing modules are configured to perform is at a level between a level of elemental mathematical functions and a level of a full draw call to a graphics processing unit.

4. The central processing unit according to claim 1, wherein the one or more graphics processing tasks of the graphics processing pipeline that the respective one or more distinct graphics processing modules are configured in dedicated hardware to perform are selected from the plurality of graphics processing tasks of the graphics processing pipeline based on an assessment of an improvement to the implementation of the graphics processing pipeline that would be achieved by performing the graphics processing task in a distinct graphics processing module configured in dedicated hardware compared to performing the graphics processing task without using a distinct graphics processing module configured in dedicated hardware.

5. The central processing unit according to claim 1, wherein the central processing unit further comprises:
a local memory;
wherein the execution unit is further configured to use the local memory when an associated one of the one or more distinct graphics processing modules is called.

6. The central processing unit according to claim 5, wherein the local memory comprises a separate memory for each of the one or more distinct graphics processing modules.

7. The central processing unit according to claim 1, wherein the instruction set architecture comprises instructions specific to each of the graphics processing modules that can be called by the execution unit.

8. The central processing unit according to claim 1, wherein the one or more graphics processing tasks comprise one or more of:
texture processing,
rasterization,
encoding,
decoding,
blending,
blitting,
graphics state management,
tessellation,
clip,
cull,
perspective divide,
viewport transform,
scan conversion,
hidden surface removal,
multi-sampling,
tiling,
ray casting,
ray tracing,
compression,
decompression,
interpolation,
gathering,
format converting,
memory management,
texture mapping,
texture decoding,
texture filtering,
testing, and
post-processing.

9. The central processing unit according to claim 1, wherein the one or more distinct graphics processing modules are configured in fixed function circuitry.

10. The central processing unit according to claim 1, wherein the instruction set is a RISC-V instruction set.

11. The central processing unit according to claim 1, wherein the execution unit is further configured to receive an output from the one or more distinct graphics processing modules configured in dedicated hardware, wherein the output represents a result of the graphics processing task performed by the one or more distinct graphics processing modules.

12. A computer-implemented method for implementing on a central processing unit a graphics processing pipeline which comprises a plurality of graphics processing tasks, the method comprising:
executing instructions of an instruction set on an execution unit of the central processing unit for implementing the graphics processing pipeline; and
performing one or more of the graphics processing tasks of the graphics processing pipeline using a respective one or more distinct graphics processing modules of the central processing unit, wherein each of the one or more distinct graphics processing modules is configured in dedicated hardware to perform one of the graphics processing tasks of the graphics processing pipeline;
wherein said executing instructions of the instruction set comprises calling each of the one or more distinct graphics processing modules using a respective instruction of the instruction set to perform its respective graphics processing task of the graphics processing pipeline.

13. The method according to claim 12, wherein the central processing unit performs one or more of the plurality of graphics processing tasks of the graphics processing pipeline without using a distinct graphics processing module configured in dedicated hardware.

14. The method according to claim 12, wherein each of the one or more graphics processing tasks of the graphics processing pipeline that are performed by the one or more distinct graphics processing modules is at a level between a level of elemental mathematical functions and a level of a full draw call to a graphics processing unit.

15. The method according to claim 12, wherein the central processing unit further comprises a local memory, and wherein the method further comprises:
using the local memory when an associated one of the one or more distinct graphics processing modules is called.

16. The method according to claim 12, wherein the instruction set architecture comprises instructions specific to each of the graphics processing modules called by the execution unit.

17. The method according to claim 12, wherein the instruction set is a RISC-V instruction set.

18. The method according to claim 12, wherein the method further comprises:
receiving, at the execution unit, an output from the one or more distinct graphics processing modules configured in dedicated hardware, wherein the output represents a result of the graphics processing task performed by the one or more distinct graphics processing modules.

19. The method according to claim 12, wherein the one or more graphics processing tasks comprise one or more of:
texture processing,
rasterization,
encoding,
decoding,
blending,
blitting,
graphics state management,
tessellation,
clip,
cull,
perspective divide,
viewport transform,
scan conversion,
hidden surface removal,
multi-sampling,
tiling,
ray casting,
ray tracing,
compression,
decompression,
interpolation,
gathering,
format converting,
memory management,
texture mapping,
texture decoding,
texture filtering,
testing, and
post-processing.

20. A non-transitory computer readable storage medium having stored thereon an integrated circuit definition dataset that, when processed in an integrated circuit manufacturing system, configures the integrated circuit manufacturing system to manufacture a central processing unit for implementing a graphics processing pipeline which comprises a plurality of graphics processing tasks, the central processing unit comprising:
one or more distinct graphics processing modules configured in dedicated hardware, wherein each of the one or more distinct graphics processing modules is configured to perform one of the graphics processing tasks of the graphics processing pipeline; and
an execution unit configured to execute instructions of an instruction set for implementing the graphics processing pipeline, wherein the execution unit is configured to call each of the one or more distinct graphics processing modules using a respective instruction of the instruction set to perform its respective graphics processing task of the graphics processing pipeline.
